(19) United States
(12) Patent Application Publication
(10) Pub. No.: US 2023/0329162 A1
(43) Pub. Date: Oct. 19, 2023

(54) Hydroponic Growing System

(71) Applicant: Drexel University, Philadelphia, PA (US)

(72) Inventors: Shivanthi Anandan, Philadelphia, PA (US); Diana Susan Nicholas, Bala Cynwyd, PA (US)

(73) Assignee: Drexel University, Philadelphia, PA (US)

(21) Appl. No.: 18/025,191

(22) PCT Filed: Sep. 29, 2021
(86) PCT No.: PCT/US2021/052502

§ 371 Date: Mar. 8, 2023

Related U.S. Application Data
(60) Provisional application No. 63/085,174, filed on Sep. 30, 2020.

(51) Int. Cl. A01G 31/02

(52) U.S. Cl. CPC A01G 31/02

(57) ABSTRACT

A hydroponic growing system includes a base member, an upper tray removably inserted into the base member, and a lid portion removably attachable to the base member. The lid portion comprises a funnel extending from a top end of the lid toward a bottom end of the lid and a sidewall having a plurality of openings formed therein.

### CROSS-REFERENCE TO RELATED APPLICATION

This application claims the benefit of U.S. Provisional Pat. Application serial No. 63/085,174, filed on Sep. 30, 2020, which is incorporated herein by reference in its entirety.

### BACKGROUND OF THE INVENTION

### Field of the Invention

The present invention relates to an in-home system for growing fruits and vegetables.

### Description of the Related Art

It is projected that by the year 2050, 68% of the world’s population will live in urban areas. One issue accompanying the increase in urban population is the distance between urban residents and their food sources. One method that can address the problems of urban food access is hydroponic farming. Hydroponics is the practice of growing plants without the use of soil, but instead with a liquid nutrient solution often accompanied by a support medium.

It would be beneficial to provide a hydroponic unit that provides a space and cost-efficient way to increase food access in urban areas.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is a hydroponic growing system that includes a base member, an upper tray removably inserted into the base member, and a lid portion removably attachable to the base member. The lid portion comprises a funnel extending from a top end of the lid toward a bottom end of the lid and a sidewall having a plurality of openings formed therein.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a perspective view of a hydroponic growing system according to an exemplary embodiment of the present invention;

FIG. 2 is a sectional view of the system of FIG. 1;

FIG. 3 is an exploded view, in section, of the system of FIG. 2;

FIG. 4 is a side elevational exploded view of an accordion insert for use with the system of FIG. 1;

FIG. 5 is a side elevational view, partially in section, of the accordion insert of FIG. 4 inserted into the system of FIG. 1;

FIG. 6 is a perspective view of a bowl insert for use with the system of FIG. 1;

FIG. 7 is a perspective view of a bottom of the accordion insert of FIG. 5;

FIG. 8 is a side elevational view of a hydroponic growing system according to another exemplary embodiment of the present invention;

FIG. 9 is a side elevational view, partially in section, of an alternative embodiment of an accordion insert inserted into the system of FIG. 8

FIG. 10 is a side elevational view of a hydroponic growing system according to another exemplary embodiment of the present invention;

FIG. 11 is a perspective view of the system of FIG. 10;

FIG. 12 is a side elevational view, in section, of the system of FIG. 10;

FIG. 13 is an exploded view, in section, of the system of FIG. 10;

FIG. 14 is a perspective view of a base member used in the system of FIG. 10;

FIG. 15 is a top plan view of the base member of FIG. 14;

FIG. 16 is a side elevational view of a lower tray used in the system of FIG. 10;

FIG. 17 is a top plan view of the lower tray of FIG. 16;

FIG. 18 is a side elevational view of an upper tray used in the system of FIG. 10;

FIG. 19 is a top plan view of the upper tray of FIG. 18;

FIG. 20 is a top plan view of a lid portion of the system of FIG. 10; and

FIG. 21 is a side elevational view of the lid portion of FIG. 20.

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

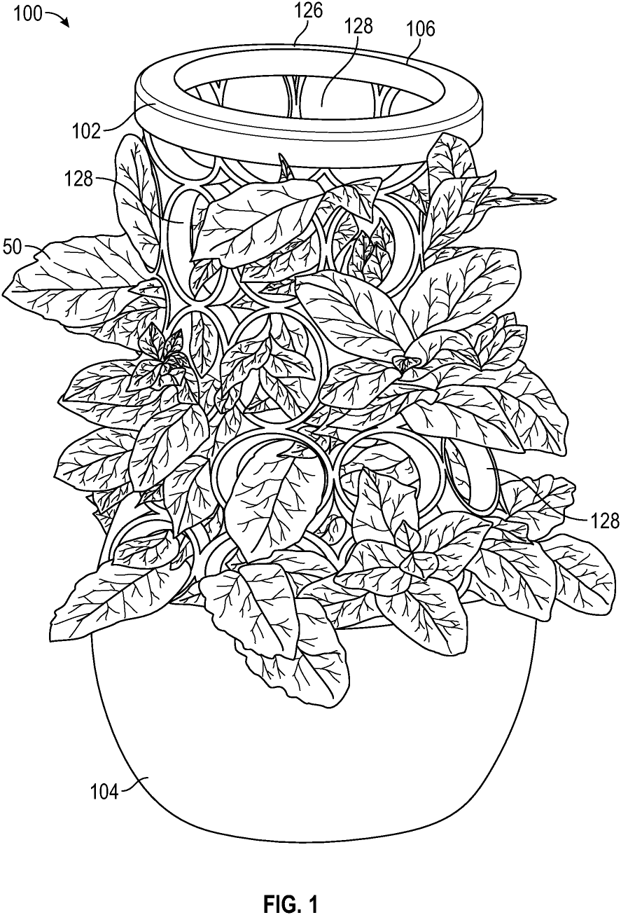

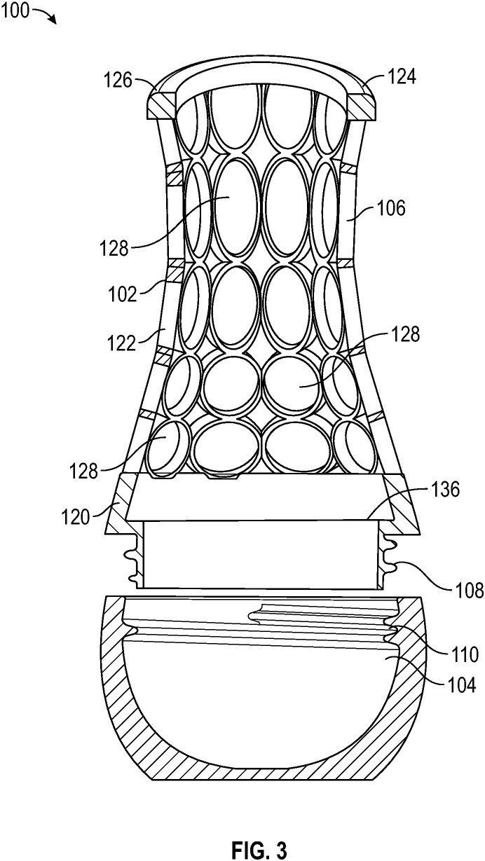

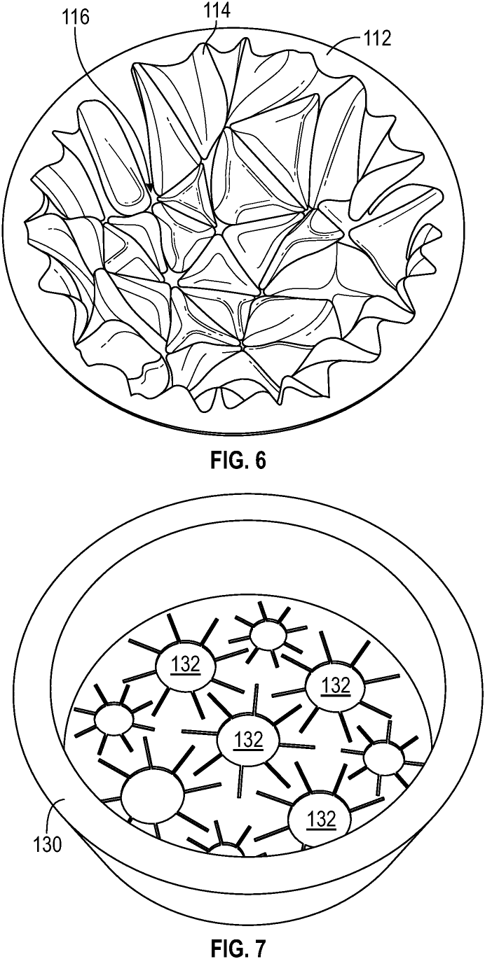

A hydroponic growing system 100 according to an exemplary embodiment of the present invention is shown in FIGS. 1-7. In an exemplary embodiment, system 100 uses nitrogen-fixing cyanobacteria algae (also known as the biomix) to provide inorganic nitrogen for growing plants in system 100, eliminating the need for soil, chemical fertilizers, or organic pesticides. System 100 is completely vegan and organic in nature, and uses ambient light.

System 100 is a symbiotic biological system and uses algae as a food source. An exemplary algae can be cyanobacterium, such as Anabaena PCC 7120. This fresh-water cyanobacterium forms heterocysts, which are specialized structures for nitrogen fixation that are formed under conditions of nitrogen limitation in their environment. As the algal cells die, cell degradation also releases and provides other nutrients for plant growth.

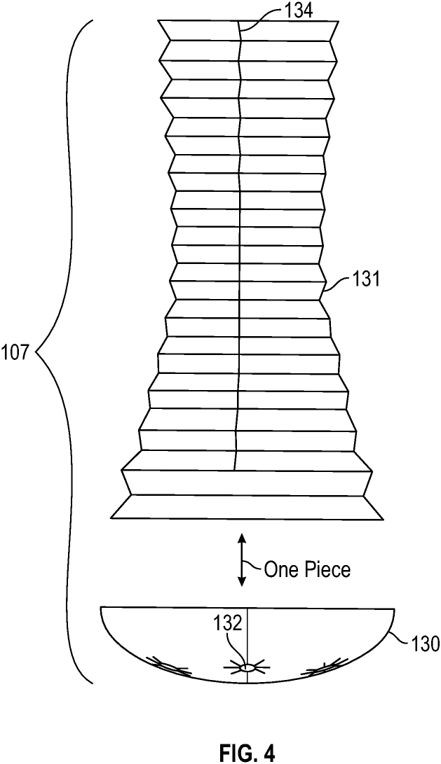

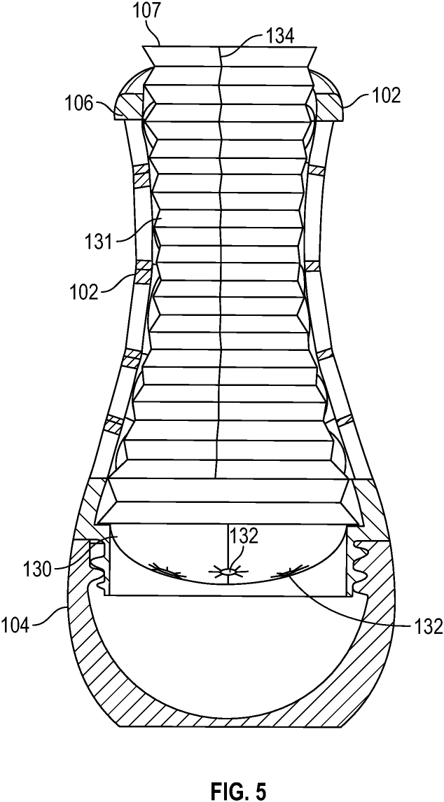

System 100 includes a vase 102 having a lower bowl 104 and an upper shell 106. Optionally, an accordion support 107, shown in FIGS. 4 and 5, can be inserted into vase 102 to vertically support larger plants. In an exemplary embodiment, vase 102 and accordion support 107 can be constructed from biodegradable plastic, glass, or other suitable biodegradable and compostable material.

Shell 106 is removably attached to bowl 104. In an exemplary embodiment, male threads 108 at the bottom of shell 106 threadingly engage female threads 110 in the top of bowl 104 to releasably attach shell 106 to bowl 104.

Optionally, a bowl insert 112 can be inserted into bowl 104. The interior 114 of insert 112 can be contoured, as shown in FIG. 6, with ridges 116 that increase the surface area of interior 114. Bowl insert 112 is configured to hold water and the algae for plant growth. Algae can be placed into bowl insert 112 in block form, can be provided with system 100 attached to interior 114 of bowl insert 112, or can be provided to system 100 in any other convenient method.

Shell 106 is shown as having a wide lower portion 120, a narrowing central portion 122, and an outwardly flared top portion 124, with a rim 126. A plurality of openings 128 are formed in shell 106 to allow plant 50 (shown in FIG. 1) to grow through. Shell structure forming openings 128 support the plant 50 as plant 50 grows out of vase 102.

Referring to FIGS. 4 and 5, accordion support 107 can be inserted inside vase 102 to help support taller plants that would grow above rim 126. Accordion support 107 can include a lower bowl portion 130 attached to a flared accordion 131. Lower bowl portion 130 keeps the plant 50 away from and above water in bowl insert 112 and can include a plurality of through-openings 132 formed therein to allow plant roots to extend through and down to bowl insert 112. The number of through openings 132 can be minimized to reduce evaporation of water from bowl insert 112.

Flared accordion 107 can be pulled upwardly through shell 106 as plant 50 grows. To accommodate for the narrow central portion 122 of shell 106, flared accordion 131 can include a seam 134 to allow flared accordion 131 to be pushed radially inwardly on itself to reduce its external perimeter size and allow flared accordion 131 to be pulled upwardly through central portion 122 of shell 106.

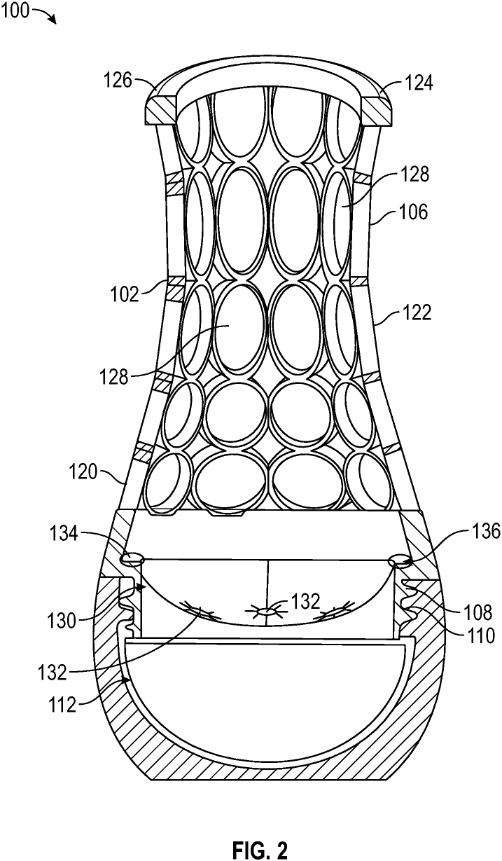

Optionally, as shown in FIG. 2, lower bowl portion 130 can be separated from flared accordion 131 and only lower bowl portion 130 is inserted into vase 102. Lower bowl portion 134 can include a radially extending lip 134 that rests on a ledge 136 toward the bottom of upper shell 106, above threads 108. Lower bowl portion 130 can also minimize water evaporation by forming a seal with lower bowl 104 while allowing plant roots to extend downwardly through openings 132.

Also, optionally, but not shown, accordion insert 131 can include a plurality of through openings so that plant 50 can grow through openings 128 in shell 106.

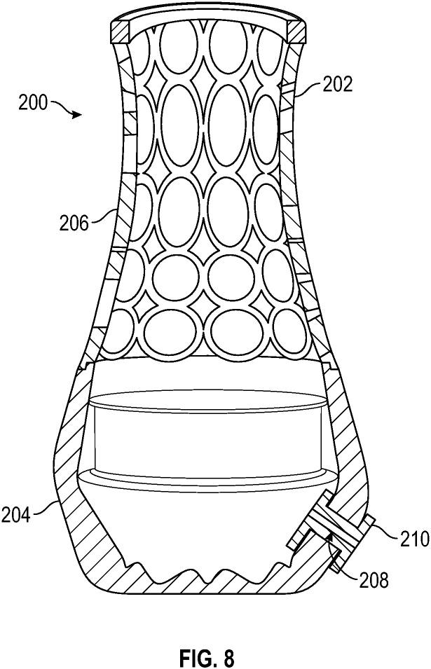

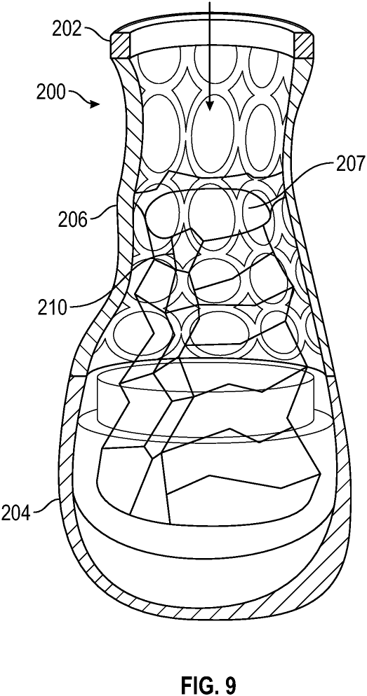

FIGS. 8-9 show a hydroponic growing system 200 according to an alternative exemplary embodiment of the present invention. System 200 includes a vase 202 having a lower bowl 204 and an upper shell 206. Optionally, an accordion support 207, shown in FIG. 9, can be inserted into vase 202 to vertically support larger plants. In an exemplary embodiment, vase 202 and accordion support 207 can be constructed from biodegradable plastic, glass, or other suitable biodegradable and compostable material.

Shell 206 is fixedly attached to bowl 204 and includes a drain 208 that easily allows for water refills. Drain 208 includes a plug 210 that seals drain 208 so that water in bowl 204 does not leak out. Plug 210 can be constructed from a flexible material, such as silicone, to allow plug 210 to be inserted into drain 208 and seal drain 208.

Optionally, an accordion support 207, similar to accordion support 107 described above, can be inserted into vase 202. Accordion support 207 can include multiple pleats 210 that allow accordion support 207 to compress radially inwardly to be able to be pulled through shell 206, similar to accordion support 107.

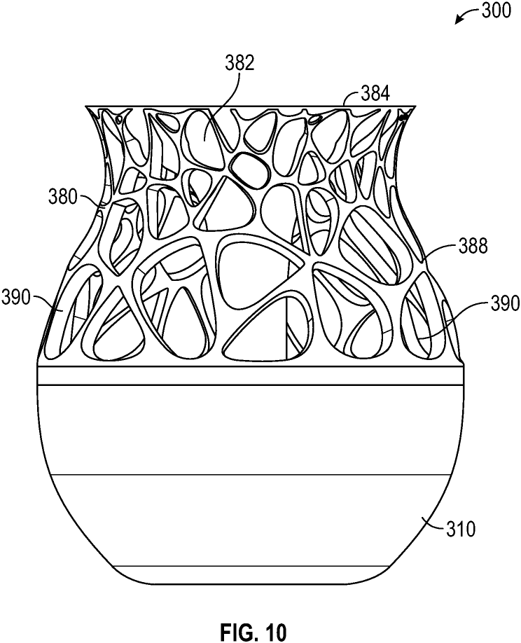

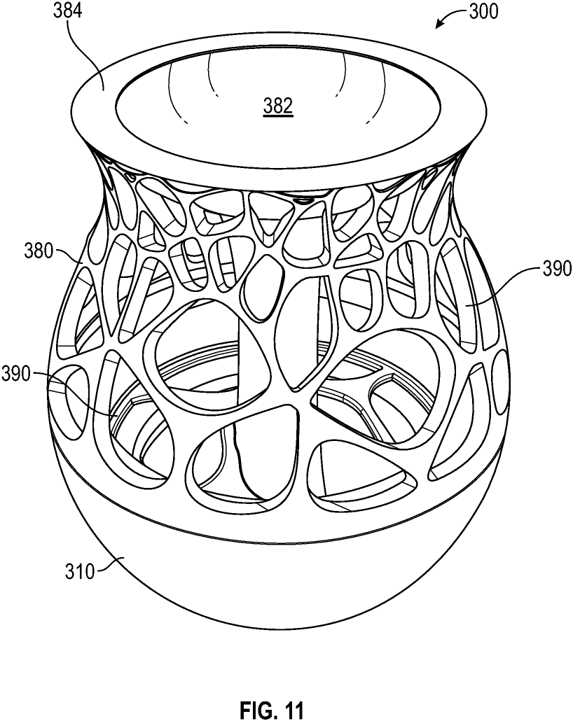

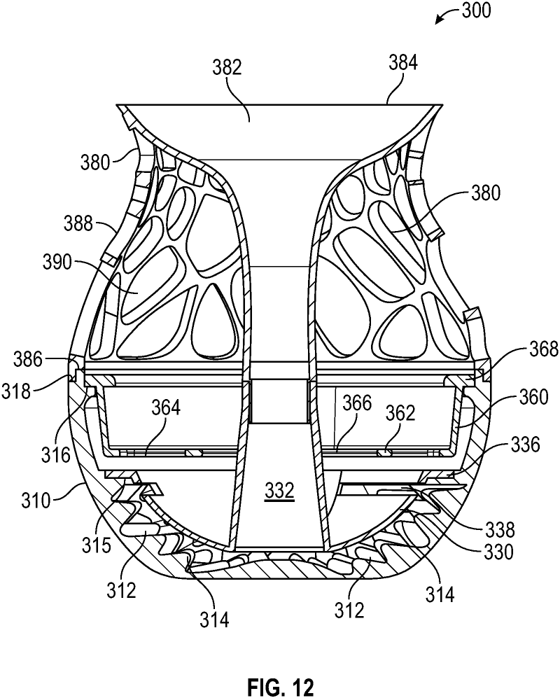

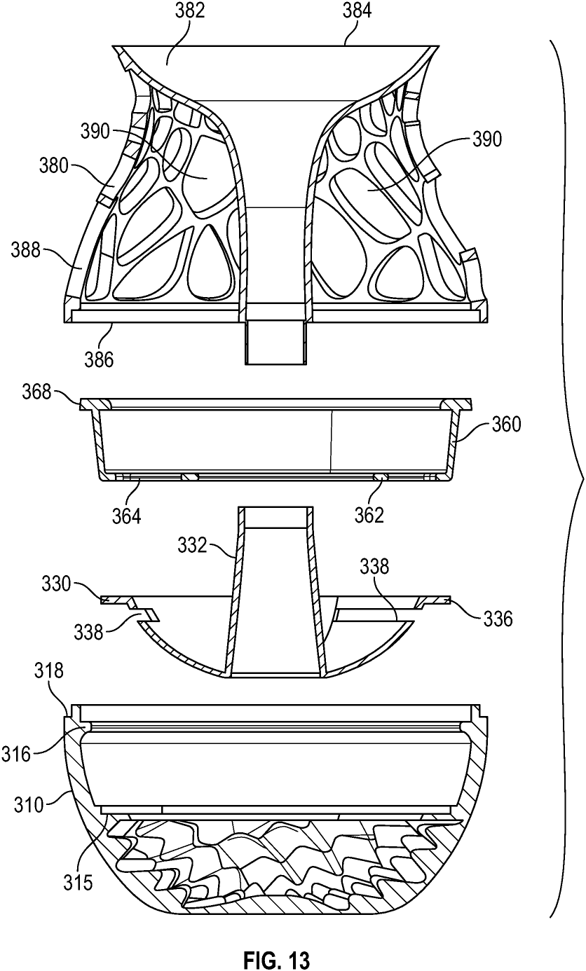

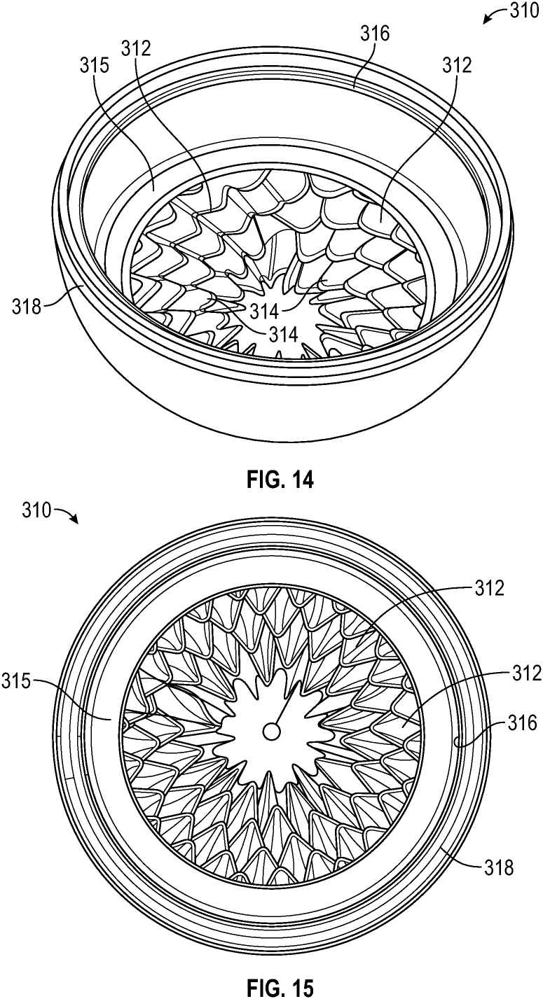

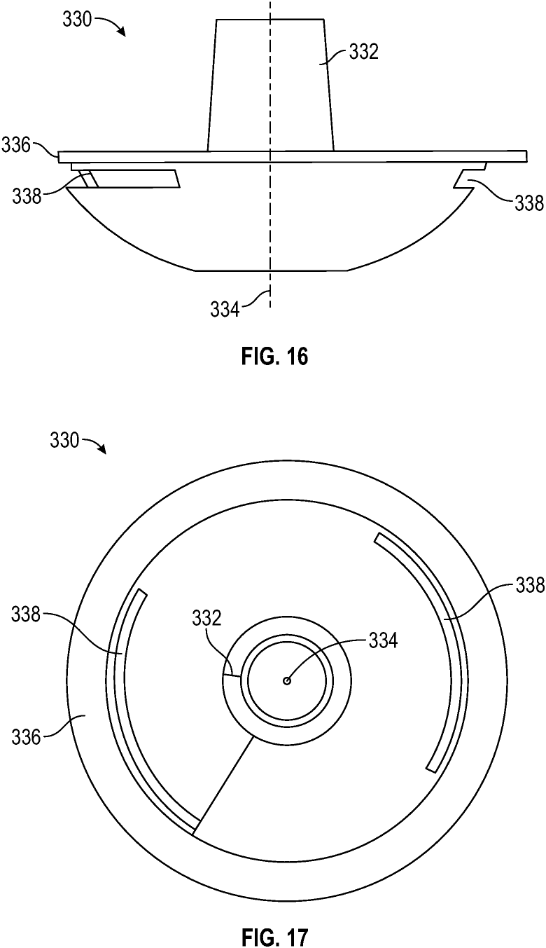

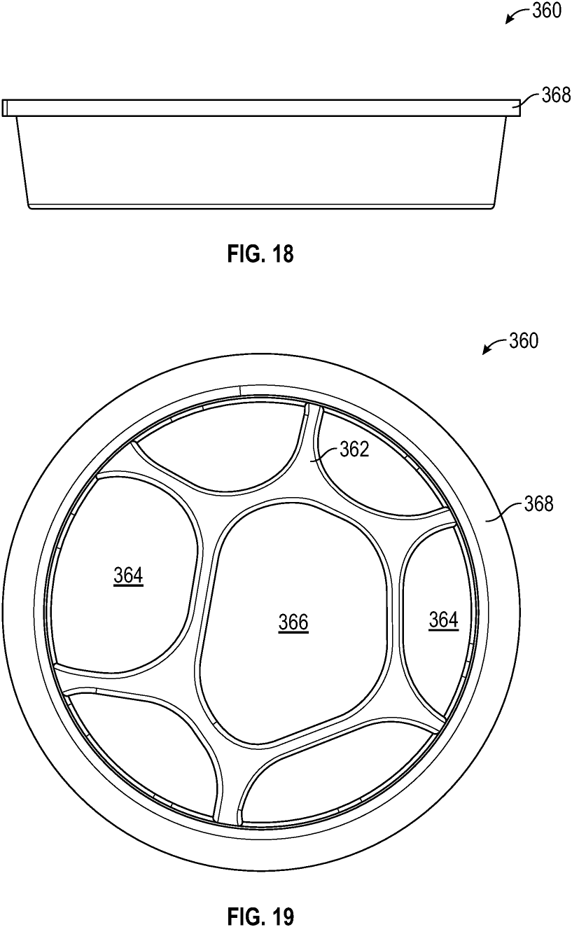

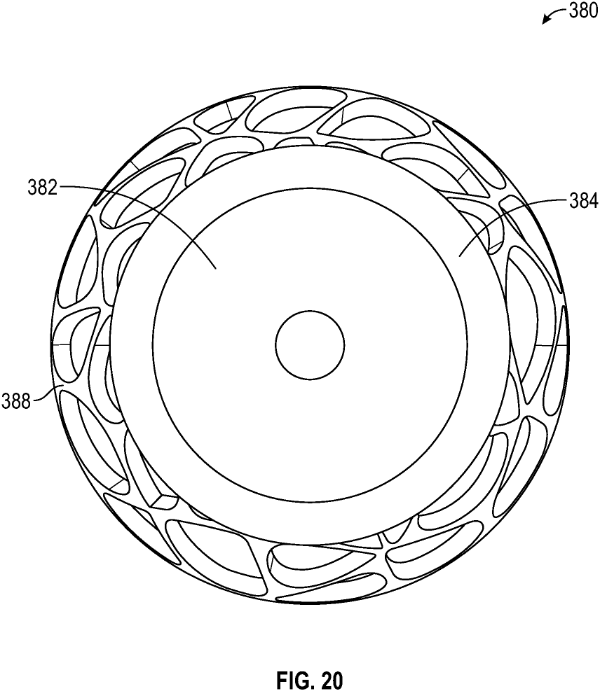

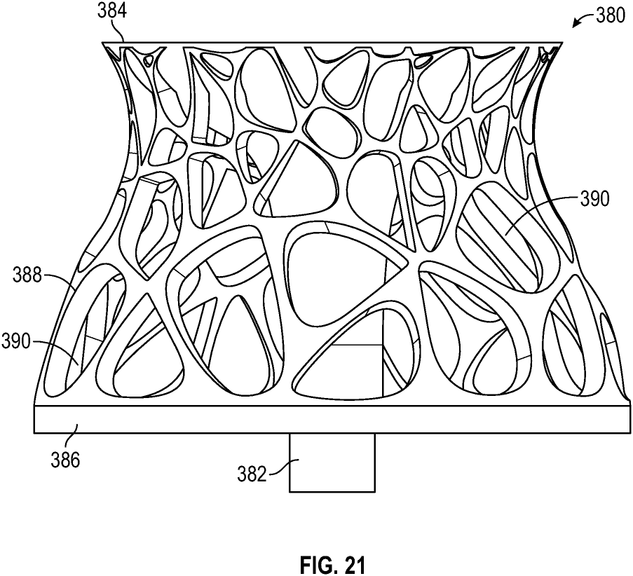

An alternative embodiment of a hydroponic growing system 300 is shown in FIGS. 10-21. System 300 includes a base member 310; a lower tray 330 and an upper tray 360, each of the lower tray 330 and the upper tray 360 removably inserted into the base member 310; and a lid portion 380 removably attached to the base member 310. In an exemplary embodiment, system 300 can be constructed from eco-friendly material, such as clay, although those skilled in the art will recognize that system 300 can be constructed from a different material as well.

Base member 310 is generally bowl-shaped and includes a plurality of raised scalloped features 312 comprises a lower inner lip extending radially inwardly toward a center of base member 310. Each scalloped of features 312 has pointed tips 314 that are directed in a downward and radially inward direction. The downwardly directed scalloped features 312 are configured to promote algae growth and adhesion, while encouraging the algae to grow toward the bottom of base portion 310, and away from plant roots above. It has been determined by the inventors that the scalloped design encourages algae growth and adhesion to base member 310.

Base member 310 also includes a lower inner lip 315 above scalloped features 312, but only about halfway up the height of base member 310. Lower inner lip 315 is provided as a platform to support lower tray 330.

Base member 310 further includes an upper inner lip 316 extending radially outwardly around a perimeter thereof to support upper tray 360, and an outer rim 318 extending around a perimeter thereof to support lid portion 380.

Lower tray 330 has a spout 332 extending along a central longitudinal axis 334. Spout 332 is configured for fluid communication with lid portion 380, as well as base member 310 such that water poured into lid portion 380 passes through spout 332 on its way to base member 310.

Lower tray 330 also includes a lower tray lip 336 extending radially outwardly around a perimeter thereof such that lower tray lip 336 is configured to rest on lower inner lip 315 so that lower lip 315 removably supports lower tray 330. Lower tray 330 has at least one through opening 338 located below lower tray lip 336. Through opening 338 is provided to allow plant roots to eventually extend therethrough so that the roots can grow toward the bottom of base member 310. Lower tray 330 is removably disposed between base member 310 and upper tray 360.

Upper tray 360 is removably inserted into base member 310. Upper tray 360 is generally bowl shaped with a support platform 362 having a plurality of through openings 364. A central through opening 366 is provided such that spout 332 can extend upwardly therethrough.

Upper tray 360 also includes an upper tray lip 368 extending radially outwardly around a perimeter thereof such that upper tray lip 368 is configured to rest on the upper inner lip 316 of base member 310.

Lid portion 380 is removably attachable to base member 310 and includes a funnel 382 extending from a top end 384 of lid portion 380 below a bottom end 386 of lid portion 380 and is attachable to spout 332 such that spout 332 is in fluid communication with funnel 382.

Lid portion 380 has an arcuate sidewall 388 having a plurality of openings 390 formed therein. Sidewall 388 is designed to provide an aesthetic exterior appearance to system 300 and to provide a support for any growth and ample light and air for the biomix. Funnel 382 engages sidewall 388 around a perimeter thereof at top end 384 of lid portion 380.

Lid portion 380 also has a seat portion 390 that extends around a perimeter thereof and is configured to rest on outer rim 318 of base member 310.

To assemble system 300, base member 310 is placed on a sturdy, level platform, such as a countertop or a floor. Lower tray 330 is placed inside base member 310 such that lower tray 330 rests on lower inner lip 314 of base member.

Upper tray 360 is then placed inside base member 310 such that upper tray 360 rests on upper inner lip 316 of base member 310 and spout 332 of lower tray extends upwardly though central through opening 366 of upper tray 360. A seed-impregnated piece of cloth material, such as felt, is placed on support platform 362 around central through opening 366 and spout 332. Moisture from water poured onto the fabric wicks through the fabric to water the seeds. When seeds begin to germinate, roots extending from the seeds pass through the material below upper tray 360 and toward lower tray 330.

Top portion 380 is then placed on top of base member 310 such that top portion rests on outer rim 318 of base member 310 and funnel 382 is in fluid communication with spout 332. System 300 can be watered by pouring an algae and water solution into funnel 382 so that the solution resides in base member 310. System 300 can also be watered by pouring water through on of openings 390 is sidewall 388 so that the water is directly applied to the seed impregnated cloth.

As roots begin to grow, the roots extend downwardly from upper tray 360 toward lower tray 330. The roots can then extend through through-opening 338 in lower tray toward the bottom of base member 310. Base member 330 keeps the roots from touching the algae for palatability. As the plant body begins to grow, the plant body grows out from sidewall 388 through openings 390 in sidewall 388.

It will be further understood that various changes in the details, materials, and arrangements of the parts which have been described and illustrated in order to explain the nature of this invention may be made by those skilled in the art without departing from the scope of the invention as expressed in the following claims.

We claim:

1. A hydroponic growing system comprising:
a base member;
an upper tray removably inserted into the base member; and a lid portion removably attachable to the base member, the lid portion comprising:
a funnel extending from a top end of the lid portion toward a bottom end of the lid portion; and
a sidewall having a plurality of openings formed therein.

2. The hydroponic growing system according to claim 1, further comprising a lower tray removably disposed between the base member and the upper tray.

3. The hydroponic growing system according to claim 2, wherein the lower tray comprises a spout configured for fluid communication with the funnel.

4. The hydroponic growing system according to claim 3, wherein the spout is in fluid communication with the base member.

5. The hydroponic growing system according to claim 2, wherein the base member comprises a lower inner lip extending radially inwardly.

6. The hydroponic growing system according to claim 2, wherein the lower tray comprises a lower tray lip extending radially outwardly around a perimeter thereof, the lower tray lip configured to rest on the lower inner lip.

7. The hydroponic growing system according to claim 6, wherein the lower tray has a through opening located below the lower tray lip.

8. The hydroponic growing system according to claim 2, wherein the upper tray comprises a support platform having a plurality of through openings extending therethrough.

9. The hydroponic growing system according to claim 8, wherein the spout extends upwardly through one of the plurality of through openings.

10. The hydroponic growing system according to claim 1, wherein the base member includes a plurality of raised scalloped features.

11. The hydroponic growing system according to claim 10, wherein the scalloped features comprise pointed tips directed generally radially inwardly.

12. The hydroponic growing system according to claim 11, wherein the pointed tips are directed in a downward direction.

13. The hydroponic growing system according to claim 10, wherein the scalloped features are configured to promote algae growth and adhesion.

14. The hydroponic growing system according to claim 1, wherein the base member comprises an upper inner lip extending radially outwardly around a perimeter thereof.

15. The hydroponic growing system according to claim 14, wherein the upper tray comprises an upper tray lip extending radially outwardly around a perimeter thereof, the upper tray lip configured to rest on the upper inner lip.

16. The hydroponic growing system according to claim 1, wherein the base member comprises an outer rim extending around a perimeter thereof.

17. The hydroponic growing system according to claim 16, wherein the lid portion comprises a seat portion extending around a perimeter thereof, the seat portion configured to rest on the outer rim.

18. The hydroponic growing system according to claim 1, wherein the funnel engages the sidewall around a perimeter thereof.
